(19) United States
(12) Patent Application Publication
(10) Pub. No.: US 2007/0095662 A1
(43) Pub. Date: May 3, 2007

(54) Structure of gas element ensuring high catalytic activity and conductivity and production method thereof

(75) Inventor: Yasufumi Suzuki, Takahama-shi (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/589,730

(22) Filed: Oct. 31, 2006

(30) Foreign Application Priority Data
Oct. 31, 2005 (JP) 2005-315882

(51) Int. Cl. G01N 27/26

(52) U.S. Cl. 204/424

(57) ABSTRACT

A gas sensor element designed to measure the concentration of gas such O₂ is provided. The gas sensor element is formed by a laminate of an oxygen ion conductive solid electrolyte layer made of zironia, a reference gas-exposed electrode, and a measurement gas-exposed electrode. The measurement gas-exposed electrode is made of a laminate of an outer electrode layer and an intermediate electrode layer. The outer electrode layer is made of metal or a mixture of the metal and zirconia. The metal is Pt, Ag, Rh, or Pd. The intermediate electrode layer is made of a mixture of zirconia and Pt, Ag, Rh, or Pd and greater in content of zirconia than the outer electrode layer. This structure results in increased reaction interfaces where the gas reacts with platinum particles and zirconia particles in the measurement gas-exposed electrode and the solid electrolyte layer, thereby ensuring higher catalytic activity and electrical conductivity.

### CROSS REFERENCE TO RELATED DOCUMENT

The present application claims the benefits of Japanese Patent Application No. 2005-315882 filed on Oct. 31, 2005, the disclosure of which is incorporated herein by reference.

### BACKGROUND OF THE INVENTION

1. Technical Field of the Invention

The present invention relates generally to an improved structure of a gas sensor element which may be built in a gas sensor employed in combustion control for automotive internal combustion engines, and more particularly to such a gas sensor element designed to ensure higher catalytic activity and conductivity, and a production method thereof.

2. Background Art

There are known gas sensors which are installed in an exhaust pipe of an automotive internal combustion engine to produce an output indicative of the concentration of oxygen (O₂). The output of the gas sensor is typically used in an engine control system to determine an air-fuel ratio of a mixture charged into the engine for combustion control thereof.

A typical one of gas sensor elements built in the above type of gas sensors consists essentially of an oxygen ion conductive solid electrolyte body containing zirconia primary, a measurement gas-exposed electrode affixed to one of opposed major surfaces of the solid electrolyte body, and a reference gas-exposed electrode affixed to the other major surface of the solid electrolyte body.

In use, the measurement gas-exposed electrode is exposed to exhaust gas from the engine and works to produce a flow of electric current between itself and the reference gas-exposed electrode as a function of the concentration of oxygen (O₂) contained in the exhaust gas.

The measurement gas-exposed electrode is usually made of a mixture of platinum (Pt) and zirconia (ZrO₂). For example, Japanese Patent First Publication No. 2001-74685 discloses such a type of measurement gas-exposed electrode. When meeting interfaces (will also be referred to as reaction interfaces below) between platinum particles and zirconia particles of the measurement gas-exposed electrode, the oxygen molecules (O₂) in the exhaust gas will be ionized to oxygen ions (O²⁻) which travel through the solid electrolyte body. Therefore, when the reaction interfaces where the exhaust gas establishes contacts with the platinum and zirconia particles are small, it may lead to the problem that the interface resistance increases undesirably between the measurement gas-exposed electrode and the solid electrolyte body. This may result in a difficulty in heating the gas sensor element up to the temperature required for activation thereof, that is, in an increased time for activating the gas sensor element.

The increasing of the reaction interfaces to ensure an operation of the gas sensor element at low temperatures may be achieved by increasing the content of zirconia in the measurement gas-exposed electrode. This will, however, result in a decrease in content of platinum, thereby decreasing the electrical conductivity of the measurement gas-exposed electrode.

### SUMMARY OF THE INVENTION

It is therefore a principal object of the present invention to avoid the disadvantages of the prior art.

It is another object of the present invention to provide an improved structure of a gas sensor element designed to ensure higher catalytic activity and electrical conductivity.

According to one aspect of the invention, there is provided a laminated gas sensor element which may be built in a gas sensor designed to measure the concentration of gas such O₂ or NOx contained in exhaust emissions from an internal combustion engine for use in an air-fuel ratio control system of automotive vehicles or diagnosing the status of a three-way catalytic converter. The gas sensor element comprises: (a) an oxygen ion conductive solid electrolyte member made of zironia, the oxygen ion conductive solid electrolyte member having a first and a second surface opposed to the first surface; (b) a reference gas-exposed electrode which is affixed to the first surface of the oxygen ion conductive solid electrolyte member and exposed to a reference gas; and (c) a measurement gas-exposed electrode which is affixed to the second surface of the oxygen ion conductive solid electrolyte member and exposed to a gas to be measured to create an electrical signal between itself and the reference gas-exposed electrode as a function of concentration of the gas. The measurement gas-exposed electrode is made of a laminate of an outer electrode layer and an intermediate electrode layer which is interposed between the outer electrode layer and the second surface of the oxygen ion conductive solid electrolyte member. The outer electrode layer is made of one of metal and a mixture of the metal and zirconia. The metal being one of a group of Pt, Ag, Rh, and Pd, the intermediate electrode layer is made of a mixture of zirconia and one of a group of Pt, Ag, Rh, and Pd and greater in content of zirconia than the outer electrode layer. This structure results in increased reaction interfaces where the gas meets the metal and zirconia, thus ensuring higher catalytic activity and electrical conductivity of the measurement gas-exposed electrode. This facilitates ease of activating the gas sensor element and permits the gas sensor element to be used in relatively lower temperatures.

In the preferred mode of the invention, a content of zirconia in the intermediate electrode layer is 10% to 50% by weight. A content of zirconia in the outer electrode layer is 13% or less by weight.

The intermediate electrode layer may be formed by a laminate of a plurality of layers in which a content of zirconia decreases as approaching the outer electrode layer.

According to the second aspect of the invention, there is provided a method of producing a gas sensor element made up of an oxygen ion conductive solid electrolyte member which is made of zironia and has a first and a second surface opposed to the first surface, a reference gas-exposed electrode which is affixed to the first surface of the oxygen ion conductive solid electrolyte member, and a measurement gas-exposed electrode which is affixed to the second surface of the oxygen ion conductive solid electrolyte member and made up of a laminate of an outer electrode layer and an intermediate electrode layer. The method comprises: (a) preparing an oxygen ion conductive solid electrolyte-forming material which is made of zirconia and has a first and a second surface opposed to the first surface; (b) preparing and placing a reference gas-exposed electrode-forming material on the first surface of the oxygen ion conductive solid electrolyte material; (c) preparing and placing an intermediate electrode layer-forming material on the second surface of the oxygen ion conductive solid electrolyte-forming material, the intermediate electrode layer-forming material being made of a mixture of zirconia and metal that is one of a group of Pt, Ag, Rh, and Pd; (d) preparing and placing an outer electrode layer-forming material on the intermediate electrode layer-forming material, the outer electrode layer-forming material being made of one of metal and a mixture of the metal and zirconia, the metal being one of a group of Pt, Ag, Rh, and Pd, the outer electrode layer-forming material being greater in content of the metal than the intermediate electrode layer-forming material; and (e) firing the oxygen ion conductive solid electrolyte-forming material, the reference gas-exposed electrode-forming material, and the outer electrode layer-forming material to complete the oxygen ion conductive solid electrolyte member, the reference gas-exposed electrode, and the measurement gas-exposed electrode.

In the preferred mode of the invention, the metal in the intermediate electrode layer-forming material may contain particles having a diameter of 10 to 1000 nm.

The metal in the intermediate electrode layer-forming material may be an organic metal alloy.

The intermediate electrode layer-forming material may contain sublimation particles having a diameter of 0.5 to 1 μm.

The intermediate electrode layer-forming material may be placed on the second surface of the oxygen ion conductive solid electrolyte-forming material using one of a paste-printing, an ink-jetting, a spattering, and an aerosol diffusion technique.

### BRIEF DESCRIPTION OF THE DRAWINGS

The present invention will be understood more fully from the detailed description given hereinbelow and from the accompanying drawings of the preferred embodiments of the invention, which, however, should not be taken to limit the invention to the specific embodiments but are for the purpose of explanation and understanding only.

In the drawings:

FIG. 1 is a transverse sectional view which shows a gas sensor element according to the first embodiment of the invention;

FIG. 2 is an exploded view which shows the gas sensor element of FIG. 1;

FIG. 3 is a partially enlarged sectional view which shows a measurement gas-exposed electrode and a solid electrolyte layer of the gas sensor element of FIG. 2;

FIG. 4 is a longitudinal sectional view which shows an example of a gas sensor in which the gas sensor element of FIG. 1 is built;

FIG. 5 is a partially enlarged sectional view which shows a measurement gas-exposed electrode according to the second embodiment of the invention;

FIG. 6 is a partially enlarged sectional view which shows a measurement gas-exposed electrode according to the third embodiment of the invention;

FIG. 7 is a longitudinal sectional view which shows an example of a gas sensor in which the gas sensor element of FIG. 1 is built;

FIG. 8 is a partially enlarged sectional view which shows a comparative example of a measurement gas-exposed electrode;

FIG. 9 is a graph which represents the results of tests of gas sensors equipped with the comparative example of the measurement gas-exposed electrode;

FIG. 10 is a graph which represents the results of tests of a gas sensor equipped with the gas sensor element of FIG. 1; and

FIG. 11 is a graph which represents values of interface resistance, as measured between a solid electrolyte layer and the measurement gas-exposed electrodes of FIG. 1 and FIG. 8.

### DESCRIPTION OF THE PREFERRED EMBODIMENTS

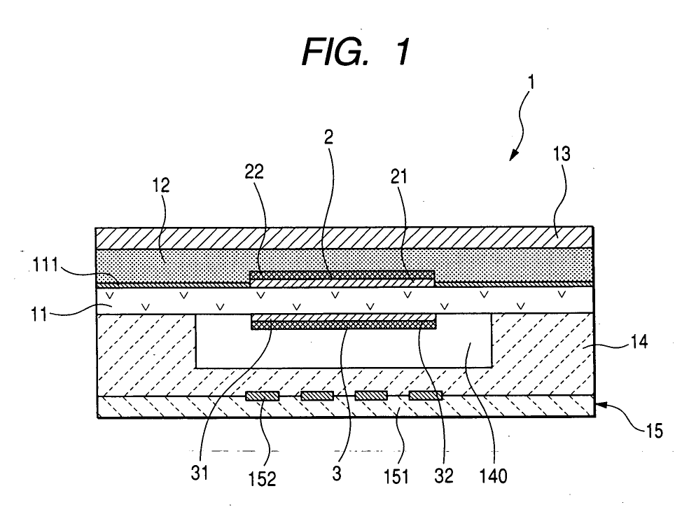

Referring now to the drawings, wherein like numbers refer to like parts in several views, particularly to FIGS. 1 to 4, there is shown a gas sensor element 1 according to the first embodiment of the invention. The gas sensor element 1 is to be incorporated within a body of a gas sensor which may be installed in an exhaust pipe of an automotive engine to measure the concentration of oxygen (O₂) contained in exhaust gasses of the engine in order to determine an air-fuel (A/F) ratio of a mixture supplied to combustion chambers of the engine for use in an exhaust emission feedback control system for controlling the combustion of the engine. An overall structure of such a gas sensor is not essential for this invention, and explanation thereof in detail will be omitted here.

The gas sensor element 1 consists essentially of an oxygen ion-conductive solid electrolyte layer 11 made mainly of zirconia, a measurement gas-exposed electrode 2 affixed to one of major surfaces of the solid electrolyte layer 11, and a reference gas-exposed electrode 3 affixed to the other major surface of the solid electrolyte layer 11.

The measurement gas-exposed electrode 2 is made up of an outer electrode layer 22 and an intermediate electrode layer 21 interposed between the outer electrode layer 22 and the solid electrolyte layer 11.

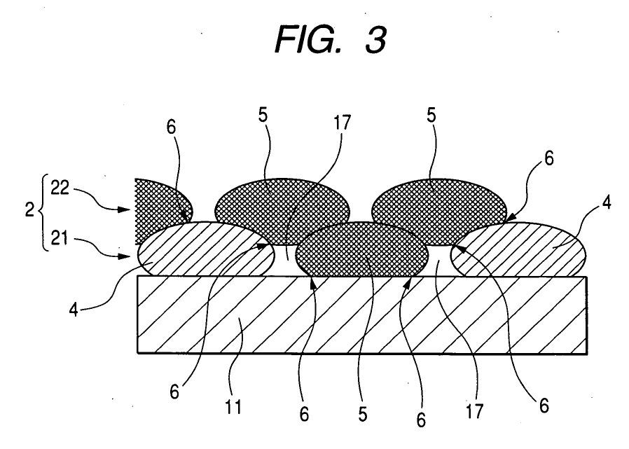

The outer electrode layer 22 is made of platinum (Pt) or a mixture of zirconia (ZrO₂) and platinum. The intermediate electrode layer 21 is made of a mixture of platinum and zirconia. The intermediate electrode layer 21 is greater in content of zirconia than the outer electrode layer 22. This results in, as illustrated in FIG. 3, increased contacts 6 of zirconia and/or platinum of the measurement gas-exposed electrode 2 with gas to be measured (will also referred to as measurement gas below). The contacts 6 will also be referred to as reaction interfaces below which are each developed at contacts among a zirconia particle 4, a platinum particle 5, and the measurement gas or among the solid electrolyte layer 11, the platinum particle 5, and the measurement gas.

The content of zirconia in the intermediate electrode layer 21 is 10% to 50% by weight. The content of zirconia in the outer electrode layer 22 is 13% or less by weight.

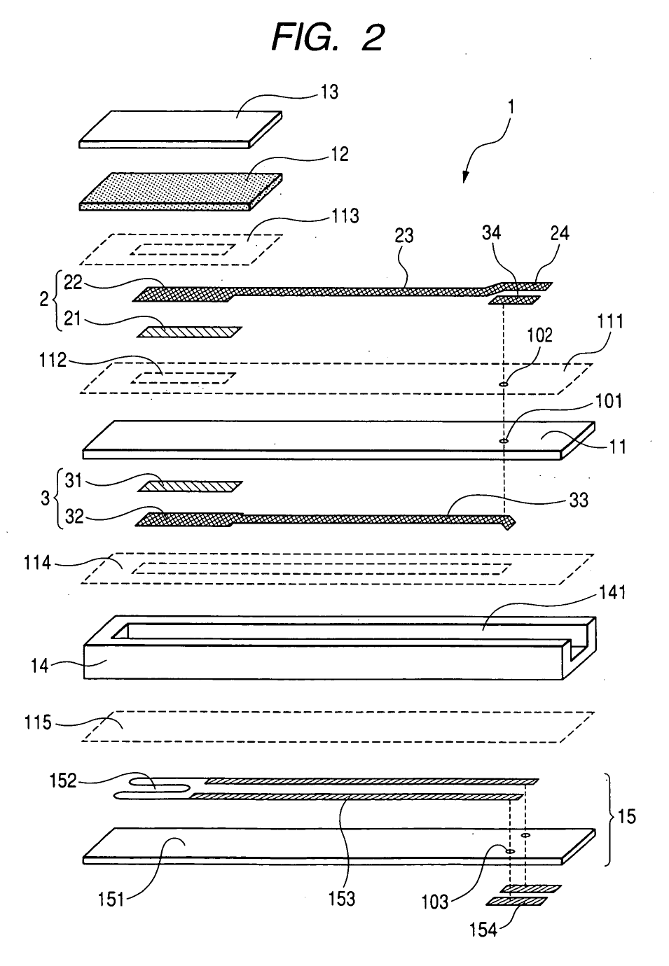

Referring back to FIGS. 1 and 2, the reference gas-exposed electrode 3 is, like the measurement gas-exposed electrode 2, made up of an outer electrode layer 32 and an intermediate electrode layer 31. The outer electrode layer 32 is made of the same compositions as the outer electrode layer 22. The intermediate electrode layer 31 is made of the same compositions as the intermediate electrode layer 21.

The gas sensor element 1 also includes a porous diffusion resistance layer 12 and a shield layer 13. The diffusion resistance layer 12 is formed over the whole of one of outer surfaces of the solid electrolyte layer 11. The shield layer 13 is formed on one of outer surfaces of the diffusion resistance layer 12.

The gas sensor element 1 also includes a spacer 14 and a heater 15. The spacer 14 is affixed to the other outer surface of the solid electrolyte layer 11 to define a reference gas chamber 140 to which a reference gas such as air is admitted and the reference gas-exposed electrode 3 is exposed. The heater 15 is affixed to an outer surface of the spacer 14 away from the spacer 14.

Referring to FIG. 2, an insulating layer 111 is affixed to the solid electrolyte layer 11. The insulating layer 111 is made of alumina and dense enough not to permit gas to pass therethrough. The insulating layer 111 has formed therein an opening or window 112 through which the intermediate electrode layer 21 of the measurement gas electrode 2 is affixed to the solid electrolyte layer 11. The outer electrode layer 22 is disposed over the intermediate electrode layer 21 and continues to a lead 23 and a terminal 24 formed on the insulating layer 111. The lead 23 and the terminal 24 are each made of the same material as that of the outer electrode layer 22.

The intermediate electrode layer 31 and the outer electrode layer 32 of the reference gas-exposed electrode 3 are affixed to the surface of the solid electrolyte layer 11 away from the measurement gas-exposed electrode 2. The outer electrode layer 32 connects with a lead 33 extending along the length of the solid electrolyte layer 11. The lead 33 is electrically connected to a terminal 24 through conductor-filled holes 101 and 102 formed in the solid electrolyte layer 11 and the insulating layer 111. The lead 33 and the terminal 34 are each made of the same material as that of the outer electrode layer 22.

A porous diffusion resistance layer 12 is disposed on a portion of the insulating layer 111 and covers the measurement gas-exposed electrode 22. A bonding layer 113 is interposed between the diffusion resistance layer 12 and the insulating layer 111 to make a firm joint therebetween. The diffusion resistance layer 12 is made of a porous aluminum material.

A shield layer 13 is disposed on the diffusion resistance layer 12. The shield layer 13 is made of an alumina ceramic which is dense and establish a gas-tight seal between itself and the diffusion resistance layer 12.

The spacer 14 is affixed through a bonding layer 114 to the surface of the solid electrolyte layer 11 on which the measurement gas-exposed electrode 3 is formed. The spacer 14 is made of an alumina ceramic which has electrical insulating properties and is dense enough not to permit gas to pass therethrough. The spacer 14 has formed therein a groove 141 which defines the reference gas chamber 140 to which the reference gas such as air is admitted.

The heater 15 is affixed to the spacer 14 through a bonding layer 115. The heater 15 is made up of a heater substrate 151 and a heating element 152 bonded to the heater substrate 151 in a given pattern. When energized electrically, the heating element 152 works to heat the gas sensor element 1 up to a desired activation temperature. The heating element 152 connects with leads 153 extending along the length of the heater substrate 151. The heating element 152 and the leads 153 face the spacer 14. The leads 153 connects electrically with terminals 154 through conductor-filled holes 103 formed in the heater substrate 151.

The measurement gas enters an end wall of the diffusion resistance layer 12 while diffusing and reaches the measurement gas-exposed electrode 2. The measurement gas-exposed electrode 2 works to reduce or ionize oxygen molecules (O₂) to produce oxygen ions (O²⁻). The oxygen ions travel through the solid electrolyte layer 11 and reach the reference gas-exposed electrode 3, thereby creating an electric current (called oxygen ion current) as a function of the concentration of oxygen (O₂) contained in the measurement gas. An external controller (not shown) samples the current flowing between the measurement gas-exposed electrode 2 and the reference gas-exposed electrode 3 and determines the concentration of oxygen. The oxygen ion current is usually produced when the solid electrolyte layer 11 is activated, that is, the temperature of the solid electrolyte layer 11 is high.

The measurement gas-exposed electrode 2 is, as described above, made up of the intermediate electrode layer 21 and the outer electrode layer 22. The intermediate electrode layer 21 is made of a mixture of zirconia and platinum and greater in content of zirconia than the outer electrode layer 22. This is schematically illustrated in FIG. 3. The intermediate electrode layer 21 is formed on the surface of the solid electrolyte layer 2 containing zirconia primary. The intermediate electrode layer 21, as illustrated in FIG. 3, contains the zirconia particles 4 and the platinum particles 5 which are mixed over the surface of the solid electrolyte layer 11. Gaps 17 are formed between the zirconia particles 4 and the platinum particles 5. The measurement gas enters the gaps 17 and creates portions of the reaction interfaces 6 that are contacts among the measurement gas, the zirconia particles 4, and the platinum particles 5. The other reaction interfaces 6 are created among the measurement gas, the platinum particles 5, and the solid electrolyte layer 11.

At the reaction interfaces 6, the oxygen molecules contained in the measurement gas are reduced to oxygen ions to produce a flow of oxygen ion current between the measurement gas-exposed electrode 2 and the reference gas-exposed electrode 3. The measurement gas-exposed electrode 2, as described above, has the intermediate electrode layer 21 in addition to the outer electrode layer 22, thus resulting in an increase in the reaction interfaces 6 as compared with when the measurement gas-exposed electrode 2 is formed only by the outer electrode layer 22.

The formation of the measurement gas-exposed electrode 2 on the solid electrolyte layer 11 is achieved by applying an intermediate electrode layer-forming raw material of a mixture of platinum and zirconia onto the surface of the solid electrolyte layer 11 and an outer electrode layer-forming raw material of platinum or a mixture of platinum and zirconia which is greater in content of platinum than the intermediate electrode layer-forming raw material onto the surface of the intermediate electrode layer-forming raw material and then firing them. For example, a paste containing zirconia primary is prepared as the intermediate electrode layer-forming raw material, printed on the surface of the solid electrolyte layer 11, and dried at 80° C. for one hour. The paste is formed by a mixture of platinum and zirconia at a weight ratio of 5:3. The intermediate electrode layer 21 has a thickness of 1 μm. Subsequently, a paste containing platinum primary is prepared as the outer electrode layer-forming raw material and printed on the intermediate electrode layer-forming raw material. The paste is formed by a mixture of platinum and zirconia at a weight ratio of 7:1. A content of zirconia is 12.5% by weight. The thickness of the outer electrode 22 is 7 μm.

On the other surface of the solid electrolyte layer 11, pastes of materials for the intermediate electrode layer 31 and the outer electrode layer 32 are printed. Afterwards, thin pastes of materials for the porous diffusion resistance layer 12, the spacer 14, etc., are applied, as illustrated in FIGS. 1 and 2. Finally, this laminate is fired to complete the gas sensor element 1.

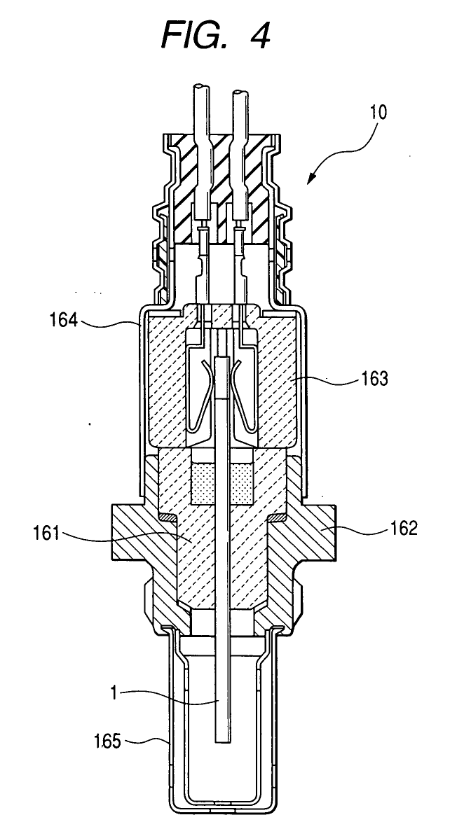

The gas sensor element 1 may be installed in a gas sensor 10, as illustrated in FIG. 4.

The gas sensor element 1 is disposed inside a porcelain insulator 161. The porcelain insulator 161 is retained inside a cylindrical housing 162. A porcelain insulator 163 is placed in alignment with the porcelain insulator 161 to cover a base end of the gas sensor element 1. An air cover 163 is joined to a base end of the housing 162 to cover the porcelain insulator 163. A protective cover assembly 165 is joined to a top end of the housing 162 to cover a top end of the gas sensor element 1. In use, the gas sensor 10 is secured at the housing 162 to an exhaust pipe of an automotive internal combustion engine.

The features of the structure of the gas sensor element 1 will be described below.

The measurement gas-exposed electrode 2 is, as described above, made of a mixture of platinum and zirconia and has the intermediate electrode layer 21 which is greater in content of zirconia than the outer electrode layer 22, thus resulting in an increase in the reaction interfaces 6 as compared with when the measurement gas-exposed electrode 2 is formed only by the outer electrode layer 22.

The oxygen molecules contained in the measurement gas meet the reaction interfaces 6 in the measurement gas-exposed electrode 2 so that they are ionized and transferred to the reference gas-exposed electrode 3 through the solid electrolyte layer 11 to produce a flow of ion current as a function of the concentration of oxygen (O₂) in the measurement gas.

The increase in the reaction interfaces 6 results in a decrease in interface resistance between the measurement gas-exposed electrode 2 and the solid electrolyte layer 11, thus increasing the ion current. This enables the gas sensor element 1 to be employed at relatively low temperatures properly and decreases the time required to activate the gas sensor element 1.

The increasing of the reaction interfaces 6 generally requires decreasing the content of platinum in the measurement gas-exposed electrode 2. When the content of platinum in the measurement gas-exposed electrode 2 is decreased as a whole, it will result in decreases in catalytic activity and electrical conductivity of the surface of the measurement gas-exposed electrode 2. In order to alleviate this drawback, the measurement gas-exposed electrode 2 is designed to have formed on the intermediate electrode layer 21 the outer electrode layer 22 which is greater in content of platinum than the intermediate electrode layer 21, thereby ensuring the catalytic activity and electrical conductivity of the surface of the surface of the measurement gas-exposed electrode 2.

Specifically, the use of the two-layer structure of the measurement gas-exposed electrode 2 permits the content of platinum in the outer electrode layer 22 to be increased and the content of zirconia in the intermediate electrode layer 21 to be increased, thereby establishing desired levels of the catalytic activity and electrical conductivity of the surface of the surface of the measurement gas-exposed electrode 2 and permitting the gas sensor element 1 to be used in relatively lower temperatures properly.

The increase in content of zirconia in the intermediate electrode layer 21 results in a decrease in stress acting between the solid electrolyte layer 11 and the measurement gas-exposed layer 2. Specifically, it results in decreases in difference in degree of shrinkage between the solid electrolyte layer 11 and the measurement gas-exposed layer 2 during firing thereof to make the gas sensor element 1 and also in difference in coefficient of thermal expansion between the solid electrolyte layer 11 and the measurement gas-exposed layer 2 when the gas sensor element 1 is heated to ensure the activity thereof, thus decreasing the internal stress remaining in the gas sensor element 1 to enhance the mechanical strength thereof and minimize pealing of the measurement gas-exposed electrode 2 from the solid electrolyte layer 11.

The reference gas-exposed electrode 3, like the measurement gas-exposed electrode 2, has a two-layer structure made up of the outer electrode layer 32 and the intermediate electrode layer 31 which is greater in content of zirconia than the intermediate electrode layer 31, thus decreasing the internal stress remaining in the gas sensor element 1 to enhance the mechanical strength thereof and minimize pealing of the reference gas-exposed electrode 3 from the solid electrolyte layer 11.

The content of zirconia in the intermediate electrode layer 21 is 10% to 50% by weight, while the content of zirconia in the outer electrode layer 22 is 13% or less by weight. This results in an increase in the reaction interfaces 6, thus permitting the gas sensor element 1 to be used at lowered temperatures and ensuring the high catalytic activity and conductivity of the outer electrode layer 22.

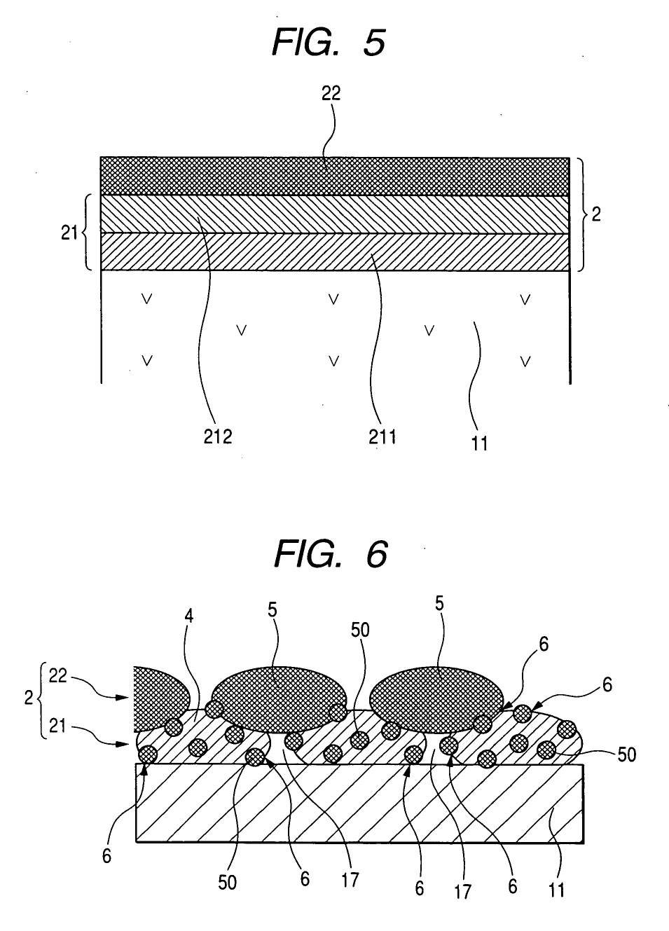

FIG. 5 illustrates the measurement gas-exposed electrode 2 according to the second embodiment of the invention which includes the intermediate electrode layer 21 of a double layer structure and the outer electrode layer 22 and which is designed to have a content of zirconia decreasing as approaching the outer electrode layer 22.

Specifically, the intermediate electrode layer 21 is made of a laminate of a first intermediate electrode layer 211 affixed to the solid electrolyte layer 11 and a second intermediate electrode layer 212 affixed to the first intermediate electrode layer 211. The second intermediate electrode layer 212 is smaller in content of zirconia than the first intermediate electrode layer 211. For instance, the content of zirconia in the first intermediate electrode layer 211 is 30% to 50% by weight, while the content of zirconia in the second intermediate electrode layer 212 is 10% to 30% by weight. Other arrangements of the gas sensor element 1 are identical with those in the first embodiment, and explanation thereof in detail will be omitted here.

The structure of this embodiment serves to disperse the stress, as produced between the solid electrolyte layer 11 and the measurement gas-exposed electrode 2 when the gas sensor element 1 is fired during production or heated during use thereof.

The intermediate electrode layer 21 may alternatively be made to have a three-layer structure in which the content of zirconia is increased as approaching the solid electrolyte layer 11 in units of the layers, that is, it is decreased as approaching the outer electrode layer 22.

Similarly, the intermediate electrode layer 31 of the reference gas-exposed electrode 3 may be made up of a laminate of a plurality of layers which is so designed that the content of zirconia is increased as approaching the solid electrolyte layer 11 in units of the layers.

FIG. 6 illustrates the measurement gas-exposed electrode 2 according to the third embodiment of the invention. The intermediate electrode layer 21 is made to contain platinum particles 50 which has a diameter of 10 nm to 1000 nm (nanometer).

The formation of the intermediate electrode layer 21 is achieved by preparing the intermediate electrode layer-forming raw paste containing the platinum particles 50 having a diameter of 10 nm to 1000 nm and printing it on the solid electrolyte layer 11 in the same manner, as described in the first embodiment.

The structure of this embodiment is effective in increasing the reaction interfaces 6 around the platinum particles 50, thus permitting the gas sensor element 1 to be used at decreased temperatures.

The intermediate electrode layer 21 of the measurement gas-exposed electrode 2 of the fourth embodiment will be described below.

The intermediate electrode layer 21 is made of the intermediate electrode layer-forming raw material containing an organic metal alloy such as platinum (Pt).

For example, a paste containing zirconia primary is prepared as the intermediate electrode layer-forming raw material, printed on the surface of the solid electrolyte layer 11 using ink-jetting techniques, and dried at 80° C. for one hour. The paste is formed by a mixture of an organic metal alloy (i.e., organic platinum) and an organic zirconia at a weight ratio of 1:1. The content of zirconia is 50% by weight. The intermediate electrode layer 21 has a thickness of 1 μm.

Subsequently, the outer electrode layer-forming raw material is printed on the intermediate electrode layer-forming raw material. The outer electrode layer-forming raw material is formed by a mixture of platinum and zirconia at a weight ratio of 7:1. The content of zirconia is 12.5% by weight. The thickness of the outer electrode 22 is 7 μm.

On the other surface of the solid electrolyte layer 11, pastes of materials for the intermediate electrode layer 31 and the outer electrode layer 32 are printed in the same matter as described in the first embodiment. Afterwards, thin pastes of materials for the porous diffusion resistance layer 12, the spacer 14, etc., are applied, as illustrated in FIGS. 1 and 2. Finally, this laminate is fired to complete the gas sensor element 1. Other arrangements of the gas sensor element 1 are identical with those in the first embodiment.

During the firing of the laminate to make the gas sensor element 1, metallic atoms in the organic platinum will remain to facilitate ease of dispersion of the platinum in the form of atoms within the intermediate electrode layer 2, thus resulting in an increase in the reaction interfaces 6 and permitting the gas sensor element 1 to be used in lowered temperatures.

The intermediate electrode layer 21 of the measurement gas-exposed electrode 2 of the fifth embodiment will be described below.

The formation of the intermediate electrode layer 21 is achieved by preparing the intermediate electrode layer-forming raw paste containing sublimation particles having a diameter of 0.5 μm to 1 μm. The content of the sublimation particles is 0.1% to 1% by weight based on the weight of platinum.

Other arrangements of the gas sensor element 1 are identical with those in the first embodiment, and explanation thereof in detail will be omitted here.

During the firing of the laminate to make the gas sensor element 1, the sublimation particles are burned out, which will form air gaps the intermediate electrode layer 21 after fired, thus resulting in an increase in the reaction interfaces 6.

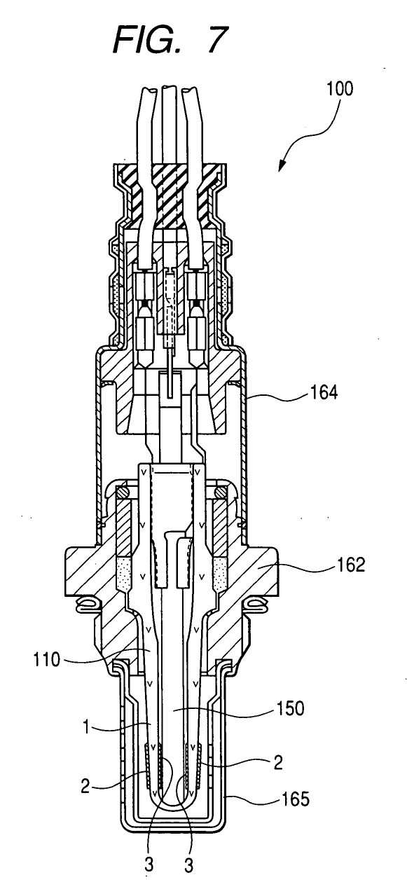

FIG. 7 shows the gas sensor element 1 installed in a gas sensor 100 according to the sixth embodiment of the invention.

The gas sensor element 1 is equipped with a cup-shaped solid electrolyte body 110. The solid electrolyte body 110, as can be seen from the drawing, has a U-shaped vertical cross section and has the measurement gas-exposed electrode 2 formed on an outer surface thereof and the reference gas-exposed electrode 3 formed on an inner surface thereof. The measurement gas-exposed electrode 2 faces the reference gas-exposed electrode 3 through the solid electrolyte body 110.

The heater 150 is disposed inside the solid electrolyte body 110 to heat the gas sensor element 1 up to a given activation temperature.

The gas sensor element 1 is retained inside the cylindrical housing 162. The air cover 164 is joined to a base end of the housing 162 to cover a base end of the gas sensor element 1. the protective cover assembly 165 is joined to a top end of the housing 162 to cover a top portion of the gas sensor element 1. Other arrangements are identical with those in the first embodiment, and explanation thereof in detail will be omitted here.

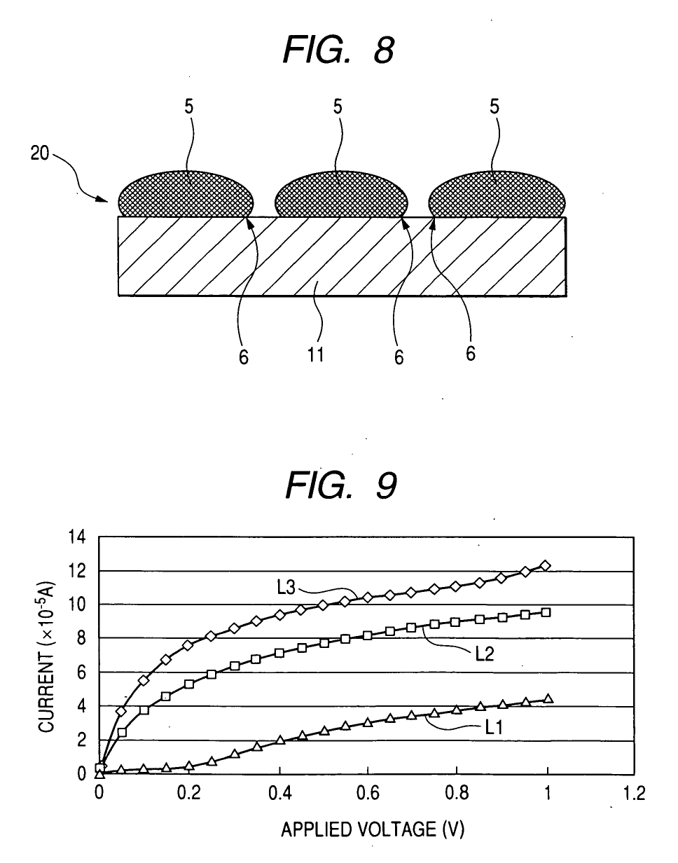

FIG. 8 illustrates a comparative example in which a single-layer measurement gas-exposed electrode 20 is used in place of the two-layer measurement gas-exposed electrode 2. The measurement gas-exposed electrode 20 does not have the intermediate electrode layer 21 and is made of the same material as that of the outer electrode 22 in the first embodiment.

The platinum particles 5 of the measurement gas-exposed electrode 20 lie on the surface of the solid electrolyte layer 11, but the reaction interfaces 6 are defined by contacts among the solid electrolyte layer 11, the platinum particles 5, and the measurement gas. Such contacts are clearly smaller than those in the structure of the measurement gas-exposed electrode 2 of the above embodiments, so that the interface resistance is greater between the measurement gas and the solid electrolyte layer 11, thus requiring the gas sensor element 1 to be kept at high temperature during use.

FIGS. 9 to 11 demonstrate results of tests to compare between the gas sensor element 1 of the first embodiment and a test specimen of a gas sensor element equipped with the measurement gas-exposed electrode 20 in the above comparative example.

First, gas sensors of the type, as illustrated in FIG. 4, having the gas sensor element 1 and the test specimen were prepared. The measurement gas whose concentration of oxygen (O₂) is 5% were prepared. The temperature of the gas sensor element 1 and the test specimen was elevated up to 550° C., 650° C., and 750° C. The voltage was applied across the measurement gas-exposed electrode 2 or 20 and the reference gas-exposed electrode 3. A flow of current, as developed between the measurement gas-exposed electrode 2 or 20 and the reference gas-exposed electrode 3 was measured.

FIG. 9 is a graph which represents the results of tests of the gas sensors equipped with the test specimen. FIG. 10 is a graph which represents the results of tests of the gas sensor equipped with the gas sensor element 1. In each of FIGS. 9 and 10, the curves L1, L2, and L3 indicate cases where the gas sensor element 1 or the test specimen was elevated up to 550° C., 650° C., and 750° C., respectively.

The graph of FIG. 9 shows that when the temperature of the test specimen is decreased down to 550° C., a required level of current will not be produced. The graph of FIG. 10 shows that even when the temperature of the gas sensor element 1 is decreased down to 550° C., a required level of current will be produced, and a required limiting current range where the current hardly increase regardless of elevation in voltage applied to the gas sensor element 1 is established, thereby permitting the gas sensor element 1 to be employed at decreased temperatures.

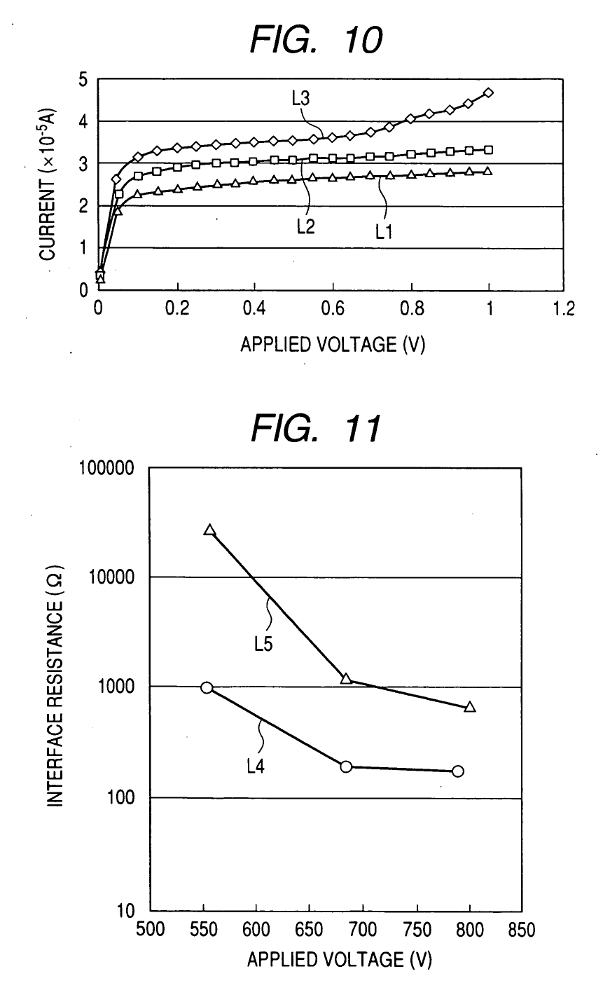

FIG. 11 is a graph which represents values of the interface resistance, as measured between the solid electrolyte layer 11 and the measurement gas-exposed electrodes 2 and 20. The curves L4 and L5 indicate data on the gas sensor element 1 and the test specimen, respectively. The graph shows that the gas sensor element 1 is greatly smaller in the interface resistance than the test specimen, that is, the use of the intermediate electrode layer 21 results in a decrease in the interface resistance, thereby facilitating ease of flow of current through the solid electrolyte layer 11.

The formation of the intermediate electrode layer 21 may be achieved by spattering or aerosol diffusion as well as the paste-printing techniques, ink-jetting techniques, or a combination thereof.

The intermediate electrode layer 21 may be made of a mixture of zirconia and silver (Ag), rhodium (Rh), or palladium (Pd) as well as platinum (Pt). The outer electrode layer 22 may be made of metal or a mixture of the metal and zirconia. The metal may be one of a group of Pt, Ag, Rh, and Pd.

While the present invention has been disclosed in terms of the preferred embodiments in order to facilitate better understanding thereof, it should be appreciated that the invention can be embodied in various ways without departing from the principle of the invention. Therefore, the invention should be understood to include all possible embodiments and modifications to the shown embodiments which can be embodied without departing from the principle of the invention as set forth in the appended claims.

What is claimed is:

1. A gas sensor element comprising:
an oxygen ion conductive solid electrolyte member made of zironia, said oxygen ion conductive solid electrolyte member having a first and a second surface opposed to the first surface;
a reference gas-exposed electrode which is affixed to the first surface of said oxygen ion conductive solid electrolyte member and exposed to a reference gas; and
a measurement gas-exposed electrode which is affixed to the second surface of said oxygen ion conductive solid electrolyte member and exposed to a gas to be measured to create an electrical signal between itself and said reference gas-exposed electrode as a function of concentration of the gas, said measurement gas-exposed electrode being made of a laminate of an outer electrode layer and an intermediate electrode layer which is interposed between the outer electrode layer and the second surface of said oxygen ion conductive solid electrolyte member, the outer electrode layer being made of one of metal and a mixture of the metal and zirconia, the metal being one of a group of Pt, Ag, Rh, and Pd, the intermediate electrode layer being made of a mixture of zirconia and one of a group of Pt, Ag, Rh, and Pd and greater in content of zirconia than the outer electrode layer.

2. A gas sensor element as set forth in claim 1, wherein a content of zirconia in the intermediate electrode layer is 10% to 50% by weight, and wherein a content of zirconia in the outer electrode layer is 13% or less by weight.

3. A gas sensor element as set forth in claim 1, wherein the intermediate electrode layer is formed by a laminate of a plurality of layers in which a content of zirconia decreases as approaching the outer electrode layer.

4. A method of producing a gas sensor element made up of an oxygen ion conductive solid electrolyte member which is made of zironia and has a first and a second surface opposed to the first surface, a reference gas-exposed electrode which is affixed to the first surface of said oxygen ion conductive solid electrolyte member, and a measurement gas-exposed electrode which is affixed to the second surface of said oxygen ion conductive solid electrolyte member and made up of a laminate of an outer electrode layer and an intermediate electrode layer, the method comprising:
preparing an oxygen ion conductive solid electrolyte-forming material which is made of zirconia and has a first and a second surface opposed to the first surface;
preparing and placing a reference gas-exposed electrode-forming material on the first surface of said oxygen ion conductive solid electrolyte material;
preparing and placing an intermediate electrode layer-forming material on the second surface of said oxygen ion conductive solid electrolyte-forming material, the intermediate electrode layer-forming material being made of a mixture of zirconia and metal that is one of a group of Pt, Ag, Rh, and Pd;
preparing and placing an outer electrode layer-forming material on the intermediate electrode layer-forming material, the outer electrode layer-forming material being made of one of metal and a mixture of the metal and zirconia, the metal being one of a group of Pt, Ag, Rh, and Pd, the outer electrode layer-forming material being greater in content of the metal than the intermediate electrode layer-forming material; and
firing said oxygen ion conductive solid electrolyte-forming material, said reference gas-exposed electrode-forming material, and said outer electrode layer-forming material to complete the oxygen ion conductive solid electrolyte member, the reference gas-exposed electrode, and the measurement gas-exposed electrode.

5. A method of producing the gas sensor element as set forth in claim 4, wherein the metal in the intermediate electrode layer-forming material contains particles having a diameter of 10 to 1000 nm.

6. A method of producing the gas sensor element as set forth in claim 4, wherein the metal in the intermediate electrode layer-forming material is an organic metal alloy.

7. A method of producing the gas sensor element as set forth in claim 4, wherein the intermediate electrode layer-forming material contains sublimation particles having a diameter of 0.5 to 1 μm.

8. A method of producing the gas sensor element as set forth in claim 4, wherein the intermediate electrode layer-forming material is placed on the second surface of said oxygen ion conductive solid electrolyte-forming material using one of a paste-printing, an ink-jetting, a spattering, and an aerosol diffusion technique.
